(19) United States
(12) Patent Application Publication
(10) Pub. No.: US 2022/0393899 A1
(43) Pub. Date: Dec. 8, 2022

(54) SYSTEM AND METHOD FOR AN ATTENTION MANAGEMENT PLATFORM AND SERVICE

(71) Applicant: Nagib Georges Mimassi, Palo Alto, CA (US)

(72) Inventor: Nagib Georges Mimassi, Palo Alto, CA (US)

(21) Appl. No.: 17/831,206

(22) Filed: Jun. 2, 2022

Related U.S. Application Data
(60) Provisional application No. 63/197,011, filed on Jun. 4, 2021.

(51) Int. Cl. H04L 12/18

(52) U.S. Cl. CPC H04L 12/1831; H04L 12/1822

(57) ABSTRACT

A system and method for an attention management platform, comprising a control server, an administrative communication means, and a database. A control server employs a plurality of protocols and instructions to monitor and control electronic devices over the Internet. An administrative communication means may be a mobile application, website, cloud-based service, or other user-interface based means by which teleconference/telemeeting participants and hosts can create and manage profiles and register electronic devices. A database stores both participant profiles and information on electronic devices. An attention management platform may be, but typically not, co-located with any participant of a teleconference/telemeeting, but allows the host of a teleconference/telemeeting (or anyone with privileges) to monitor and control the electronic devices of the other participants in the teleconference/telemeeting.

### CROSS-REFERENCE TO RELATED APPLICATIONS

Priority is claimed in the application data sheet to the following patents or patent applications, the entire written description of each of which is expressly incorporated herein by reference in its entirety:

63/197,011

### BACKGROUND

### Field of the Art

The disclosure relates to the field of remote computer management, and more particularly to the field of remote monitoring and remote control of computing systems.

### Discussion of the State of the Art

Pandemics, culture shifts, and technology are normalizing the ever-increasing physical distance people are keeping between each other. This can be seen by the rapid shift in telework and telelearning (distance learning) largely due to the COVID-19 pandemic in the just the year 2020 alone. However, other factors have driven the desire for telework and telelearning such as housing shortages, longer commute times, and inflation rates. Whatever the reason for the increase in telework and telelearning, there is now a strong need for tele-applications such as Skype, Zoom, and Microsoft Teams to name a few. One downside to telework/telelearning, is that some individuals are not working or paying attention during those teleconference/telemeetings. For example, students may often be found playing video games or texting during a telelearning session, instead of paying attention.

There are instances where employers, teachers, and other professionals have the need to monitor other parties during a teleconference/telemeeting. Whether that teleconference/telemeeting is an 8 hour workday, or a 60-minute class session for young school-age child, there is a market for telemonitoring. Now, there already exists some employee monitoring applications, but these only at most record keystrokes, take screenshots, and make use of the resources of the one computer used by the monitored individual. Both adults and children are clever, and can already find easy ways to defeat such “state-of-the-art” employee monitoring software.

What is needed is not just an employee monitoring software, but an improved system and method for monitoring and remotely controlling participant devices, and using that in keeping the attention of employees, students, and participants directed where consensually desired.

### SUMMARY

Accordingly, the inventor has conceived and reduced to practice, a system and method for an attention management platform, comprising a control server, an administrative communication means, and a database. A control server employs a plurality of protocols and instructions to monitor and control electronic devices over the Internet. An administrative communication means may be a mobile application, website, cloud-based service, or other user-interface based means by which teleconference/telemeeting participants and hosts can create and manage profiles and register electronic devices. A database stores both participant profiles and information on electronic devices. An attention management platform may be, but typically not, co-located with any participant of a teleconference/telemeeting, but allows the host of a teleconference/telemeeting (or anyone with privileges) to monitor and control the electronic devices of the other participants in the teleconference/telemeeting.

According to a first preferred embodiment, a system for attention management is disclosed, comprising: an attention management platform comprising at least a plurality of programming instructions stored in a memory of, and operating on at least one processor of, a computing device, wherein the plurality of programming instructions, when operating on the at least one processor, causes the computing device to: receive a new account profile, wherein the new account profile comprises a plurality of information about a participant; receive one or more electronic device profiles associated with the new account profile, wherein each of the one or more electronic device profiles comprises information about one electronic device, and wherein the information about one electronic device comprises an address of the one electronic device used for communication and an active status relating to the ability to monitor and control said device; initiate a teleconference between at least two participants, wherein at least one of the participants is a host; retrieve the status of all the active electronic devices associated with all the participants, except the host, in the teleconference; receive instruction from the host regarding which of the active electronic devices are authorized; create an alert if an unauthorized electronic device is used; receive an instruction from the host regarding the unauthorized electronic device; and perform the instruction from the host regarding the unauthorized electronic device.

According to a second preferred embodiment, a method for attention management is disclosed, comprising the steps of: receiving a new account profile, wherein the new account profile comprises a plurality of information about a participant; receiving one or more electronic device profiles associated with the new account profile, wherein each of the one or more electronic device profiles comprises information about one electronic device, and wherein the information about one electronic device comprises an address of the one electronic device used for communication and an active status relating to the ability to monitor and control said device; initiating a teleconference between at least two participants, wherein at least one of the participants is a host; retrieving the status of all the active electronic devices associated with all the participants, except the host, in the teleconference; receiving instruction from the host regarding which of the active electronic devices are authorized; creating an alert if an unauthorized electronic device is used; receiving an instruction from the host regarding the unauthorized electronic device; and performing the instruction from the host regarding the unauthorized electronic device.

According to various aspect; wherein an application available for participant electronic devices is communicatively coupled to the attention management platform; wherein the application allows the host to remotely monitor and control the electronic device of which the application is installed; wherein a third party software initiates the teleconference; wherein an API is provided for the third party teleconference software to utilize the functions of the attention management platform; wherein the instruction from the host is a command to turn the electronic device off or on; wherein the instruction from the host is a command to send a notification to the participant to turn the electronic device off or on; wherein the electronic devices' address used for communication comprises a physical CEC address and a logical CEC address; wherein the electronic devices' address used for communication comprises an IP address; wherein the electronic devices' address used for communication comprises a remote desktop protocol address.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a block diagram illustrating an exemplary system architecture for an attention management platform.

FIG. 2 is a diagram of an exemplary floor plan illustrating one possible combination of household electronics that are controlled and monitored by an attention management platform.

FIG. 3 is a diagram of an exemplary floor plan illustrating a second possible combination of household electronics that are controlled and monitored by an attention management platform.

FIG. 4 is a diagram of an exemplary floor plan illustrating a third possible combination of household electronics that are controlled and monitored by an attention management platform.

FIG. 5 is a diagram illustrating an exemplary user interface that a host of a teleconference/telemeeting may be presented with by an attention management platform.

FIG. 6 is a diagram illustrating an exemplary user interface element that a participant of a teleconference/telemeeting may be presented with to register his or her devices by an attention management platform.

FIG. 7 is another diagram illustrating an exemplary user interface element that a participant of a teleconference/telemeeting may be presented with to register his or her devices by an attention management platform.

FIG. 8 is a flow diagram illustrating an exemplary method for monitoring and controlling teleconference/telemeeting participant's devices by a host of the teleconference/telemeeting.

FIG. 9 is a block diagram illustrating an exemplary hardware architecture of a computing device.

FIG. 10 is a block diagram illustrating an exemplary logical architecture for a client device.

FIG. 11 is a block diagram showing an exemplary architectural arrangement of clients, servers, and external services.

FIG. 12 is another block diagram illustrating an exemplary hardware architecture of a computing device.

### DETAILED DESCRIPTION

The inventor has conceived, and reduced to practice, a system and method for an attention management platform, comprising a control server, an administrative communication means, and a database. A control server employs a plurality of protocols and instructions to monitor and control electronic devices over the Internet. An administrative communication means may be a mobile application, website, cloud-based service, or other user-interface based means by which teleconference/telemeeting participants and hosts can create and manage profiles and register electronic devices (i.e., what hardware and software is present on common technologies—e.g., if a specific television is CEC enabled or not as one example). A database stores both participant profiles and information on electronic devices. An attention management platform may be, but typically not, co-located with any participant of a teleconference/telemeeting, but allows the host of a teleconference/telemeeting (or anyone with privileges) to monitor and control the electronic devices of the other participants in the teleconference/telemeeting.

The system and method work by having each participant register with the attention management platform. This typically includes submitting a name, age, and host/entity/employer/school/etc. The host being potentially anyone but namely an employer, school, or other establishment. This may be done by searching for the host's profile, or by a QR code, or an alphanumeric code, URL link, or some other type of unique identification key. Also, participants register his or her electronic devices. This may entail choosing the type of device, the make, model, and other features relevant to the type of device. This allows an attention management platform to know how to control the registered device.

A host of a teleconference/telemeeting is given access to a user interface where he or she may monitor and send commands to his or her teleconference/telemeeting participant's devices. For example, a teacher may have 20 students and each student has at least a computer registered, but also likely a webcam, microphone, and possibly a video game system, smart television, and even one or more social media presences. The teacher will receive alerts on the user interface when the system detects when a student's registered device is turned on, or in use, or otherwise in an undesirable state. The teacher can then perform a myriad of options such as sending a standby command—which puts the device to sleep—or notifying the student to turn it off or notifying a parent. The ways in which the system detects devices and their status' is varied as is as the protocols that may be used. However, it is likely that between CEC and remote desktop protocols almost all modern devices can be monitored and controlled over the Internet. The list of possible commands and options available to the teacher (or any host) across all potential communication protocols/means is too vast to list here. However, those with ordinary skill in the art will appreciate the anticipated possibilities implied herein.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Conceptual Architecture

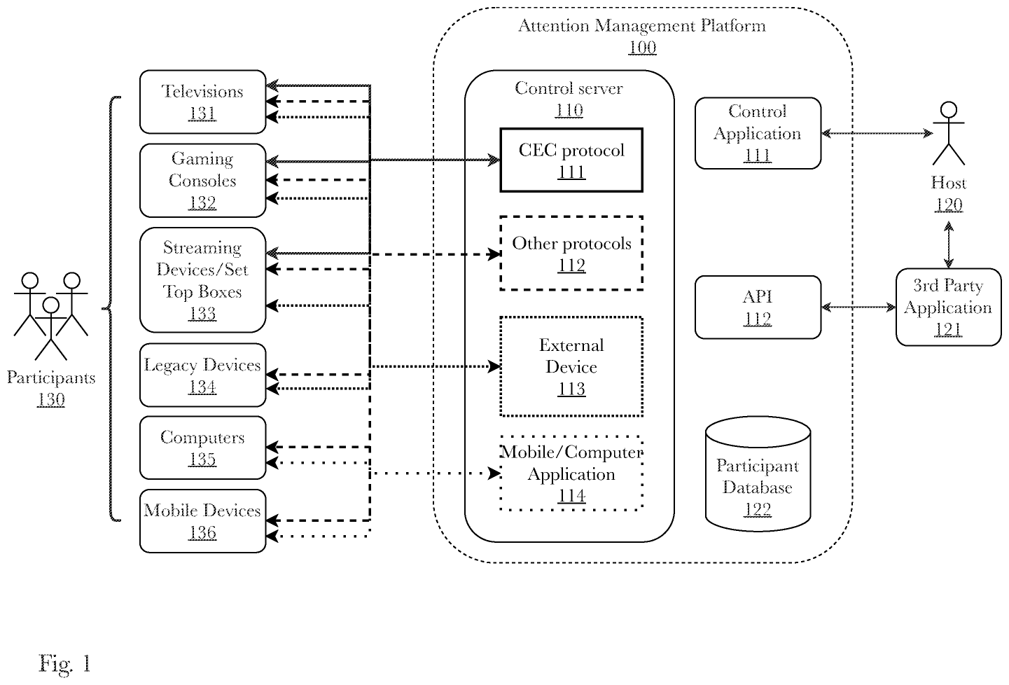

FIG. 1 is a block diagram illustrating an exemplary system architecture for an attention management platform 100. An attention management platform 100 is designed to allow the host 120 of a teleconference/telemeeting to monitor and control any type of electronic device 131-136 that belongs to a participant 130 in the teleconference/telemeeting, ergo, at least substantially manage the attention of teleconference/telemeeting participants by curtailing electronic distractions. An attention management platform 100 offers various ways to accomplish this depending on the teleconference/telemeeting vehicle. An attention management platform 100 may provide a control application 111 which may comprise a portal-type webpage-based service for which the host/participants may register and login over the Internet 111. A control application 111 may be a cloud-based service or set up to be an on-premises system. More specifically, a control application 111, is any set of instructions that allows the host 120 to centrally monitor and manage all the devices 131-136 registered with the control server 110, regardless of the protocol 111-114. An API (application programming interface) 112 may be used (alone or in parallel with a control application 111) by existing third party applications 121 such as ZOOM™, MICROSOFT TEAMS™) and SKYPE™ to integrate some or all features of an attention management platform 100. Some example API calls may be to get the status of a device, to power a device on or off, kill a process on a remote computer, etc. Regardless of the vehicle, participants 130 may need to set up an account where they can register owned devices. The participants accounts and associated devices may be stored in a participant database 122.

A varied many electronic devices exist, and to monitor and control them, a few select protocols and devices may be employed. Not all protocols and devices serving such a purpose are disclosed herein but will be known to those with ordinary skill in the art and anticipated/implied herein. Protocols and the associated instructions used for communication with devices are centrally implemented in a control server 110. A control server 110 may employ such protocols as CEC (Consumer Electronic Control) 111 and it's branded variants. Other communication protocols 112 may be used such as Wi-Fi, LoRa, NB-IoT, Thread, Bluetooth, Bluetooth Low Energy, HTTP, FTP, NFC, and IR to name a few. Remote protocols 112 also fall into the category of communication protocols and may used as such. Some examples are MICROSOFT'S Remote Desktop Protocol and Remote FrameBuffer (VNC). There is no limit to which communication protocol may used as long as the protocol serves to allow monitoring and/or remote control of one device from another device.

Some devices that are “offline” or feature no usable communication protocol (named legacy devices 134 herein) may be controlled and monitored via external devices 113. A CEC-over-IP device is one such device and allows CEC commands over a network. Another device suggested for use is a “smart plug”. Where a “smart plug” is a small device that is connected between the electrical receptacle powering the device and the plug of the electrical device itself. Such a device may monitor volts, amps, and other properties to determine the status of a device. A smart plug may also remember the last state of the device as well. A CEC-over-IP and smart plug are only two examples of devices that can enable legacy devices to work with an attention management platform 100.

For mobile devices 136 such as tablets, phones, smart watches, and other “untethered” devices and as well as laptops and desktop computers, an application 114 may be installed. A mobile/desktop application 114 may use one or more of the aforementioned (or implied) communication protocols that is communicatively coupled with the control server 110.

Together, the various communication protocols 111/112, external devices 113, and mobile/desktop applications 114 will enable the monitoring and control of nearly every electronic device found in homes across in at least the United States, if not worldwide.

Other anticipated aspects of monitoring and/or control, but not focused on herein, include monitoring social media accounts, detecting patterns or activity from Wi-Fi enabled devices (e.g., lights, speakers, thermostats, etc.), packet sniffing, and sensors (e.g., pressure sensors, motion sensors, etc.). Monitoring social media accounts may require that the control server is given some level of view privileges for the participant's accounts. Almost all social media platforms have some type of API to that extent. Packet sniffing may reveal undesired/unauthorized internet activity. Typically, sensors that may be used for detecting the presence and attention of an individual are not found in today's homes. However, under some circumstances and according to some embodiments, such sensors may be present for said purpose. Possibly in a business establishment, mental health facility, or a school. The lack of mentions hereafter of the various aspects contained within this paragraph is not meant to exclude from any envisioned embodiments.

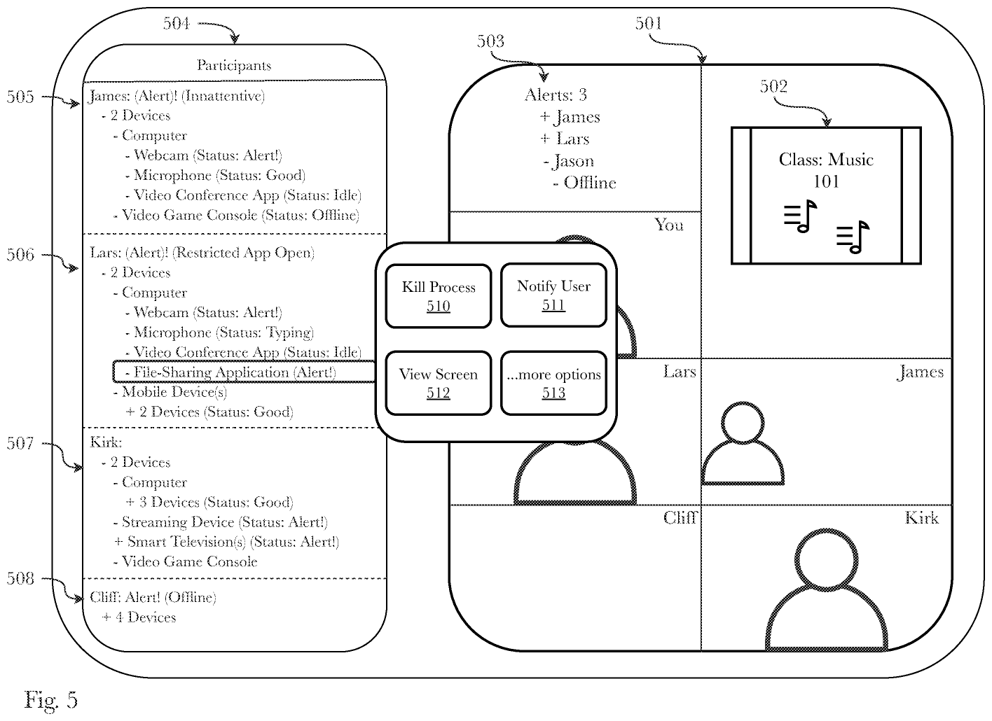

FIG. 5 is a diagram illustrating an exemplary user interface that a host of a teleconference/telemeeting may be presented with by an attention management platform. This exemplary user interface (UI) simplifies general features that may be present but is not an all-encompassing representation of all features that may be present. This diagram illustrates one of the main features of an attention management platform, namely the ability to remotely monitor and control participant's devices.

Shown here is an UI element 501 comprising a video of each the participants, host, a screensharing window 502, and a snapshot view of monitored participants 503—or more specifically, the participant's devices. Also shown here is an UI element 504 that comprises details about each participant and their devices and the ability to control them.

Imagine that there is a professor teaching a Music 101 class to four students: James 505, Lars 506, Kirk 507, and Cliff 508. It is visible from the diagram that each participant has a collapsible tree under his or her name. The professor—host of the teleclass—would be able to see that James 505 is not paying attention. This may be detected from facial recognition algorithms on the control server using the James' webcam. Possibly James is off in the distance and his computer has gone idle. Potentially a pressure sensor or motion sensor in James' immediate vicinity is reporting to the control server.

The professor may also see that Lars has opened and is using a file sharing application. This may be detected by monitoring processes/services on the participant's computer. The professor may on any device, but only shown here for the file sharing application, be presented with a variety of options 510-513. This would allow the professor to remedy the situation, i.e., control the attention of the participant.

As just another example, the professor may notice that Kirk 507 is streaming media on one of his televisions. Just as with Lars, the professor may select the devices and choose an option to refocus Kirk 507. In the case of CEC devices, one option may be to place the device in standby.

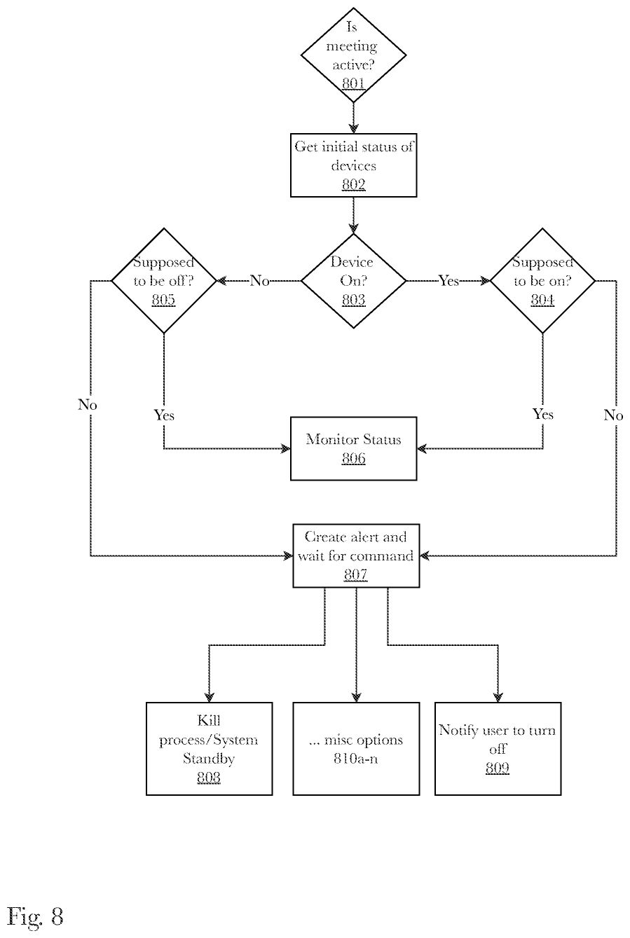

FIG. 8 is a flow diagram illustrating an exemplary method for monitoring and controlling teleconference/telemeeting participant's devices by a host of the teleconference/telemeeting. According to one embodiment, the monitoring and ability to control participant's devices may only begin when the teleconference/telemeeting starts 801. A next step would comprise getting an initial state of all the applicable (registered and active) devices for each participant 802. In a third step 803, each applicable device is determined if it is on or off and whether it is allowed by the host 804/805. There are many methods to determine allowability of devices. One such method would be by establishing a group policy object set before hand, typically by the administrator of the school, business, or establishment. This may look like configuring the group policy that all video game consoles are not allowed by default, etc. Additionally, there may be settings where a host cannot override the group policy set by an employer or school, or may be the host has full control. Another such method is where the host may manually select each device, or devices grouped by certain classifications, at the start of the teleconference. The typical preferences/options that are available and found in most software applications are anticipated herein. Should the applicable device be in a satisfactory state, then the device will just continue to be monitored 806. If the device is not in a satisfactory state, an alert will be created and upon receipt of an instruction 808-810a-n from a host, the instruction will be carried out 807.

### Detailed Description of Exemplary Aspects

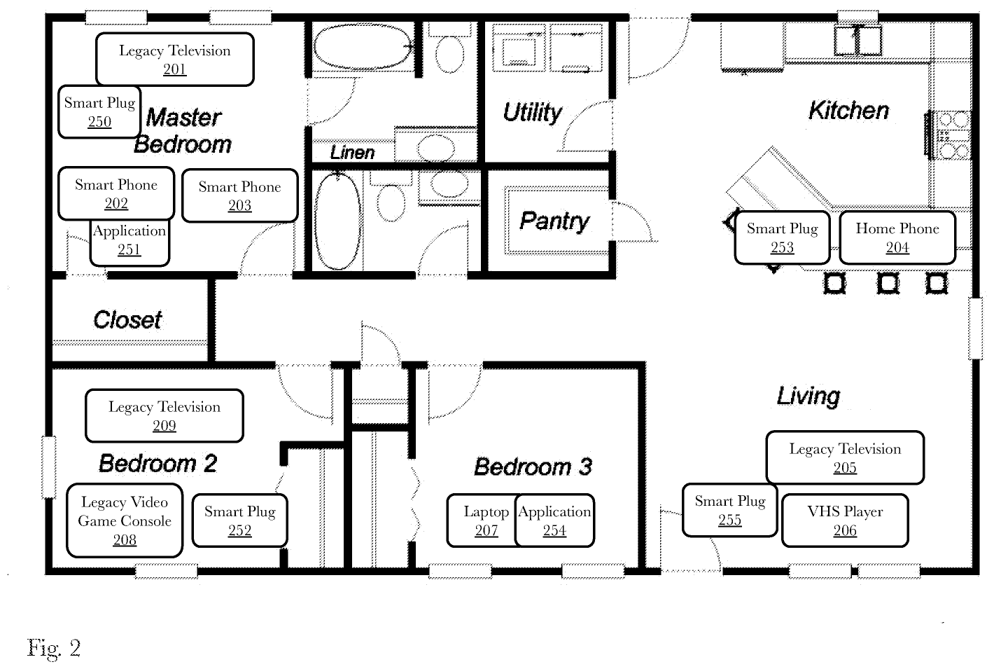

FIG. 2 is a diagram of an exemplary floor plan illustrating one possible combination of household electronics that are controlled and monitored by an attention management platform. This diagram is an example of a household with fairly antiquated technology in terms of how fast new devices become available. This diagrams also assumes a family of four, two adults and two school age children. Imagine that both school age children are participating in distance learning due to a pandemic. Imagine further that one of the parents has also transitioned to telework due to the same pandemic. Consider now that both the school of the children and the employer of the one parent utilize a cloud-based implementation of an attention management platform and service. Therefore, both the school and the employer may require an adult to create an account and associate some or all the electronic devices 201-209 in his or her home. This does not mean the school and the employer are aware of each other but may be using the same cloud-based attention management service/platform.

Users may create an account by using a mobile app or website where users can download or log on, respectively, in order to satisfy account creation. The created account not only has at least the name of a potential participant of a teleconference/telemeeting, but also associated electronic devices. Typical account requirements found in modern businesses and services are anticipated but not required such as birthday, sex, email, phone number, etc. In some instances, as will soon be described, the number of required external devices 250-255 for legacy devices may be determined and subsequently ordered and installed. The process of determining which devices needs an external device may be automated as the user inputs some or all the various devices in his or her home. This may be implemented with a simple database of common electronics complete with a list of their built-in technologies. External devices may be supplied by the employer or school or required to be purchased by the user. Any number of business methods/models may be employed to ensure external devices are properly in place for use by an attention management platform. The smart plugs shown in the diagram 250-255 are assumed to be voltage-sensing or amp-sensing Wi-Fi enabled smart plugs such that if a legacy device is powered on, the control server is notified of the device's status over the Internet.

When the one parent registers his or her devices, they may be asked which household devices they are required (or desire) to register to the one parent's profile. This is separate than when the one parent creates an account for his or her children and will assumedly choose the devices only belonging to or used by the child. For example, the one parent's employer may require that only electronic devices that he or she uses be registered, or possibly that all household devices be registered. If the former is the requirement, then the one parent may only register legacy television 201, his or her smart phone 202, the home phone 204, VHS player, and the legacy television 205, and not the devices of his or her spouse 203 and children 207-209. However, for each child account, the child's devices would be the only ones registered, unless the school requires all household devices to be registered. The decision of how many and which devices to register may depend on many factors such as age, time of day, and trustworthiness to name a few.

It may be that both the children and the parent share the one laptop 207 for each teleconference/telemeeting. Laptops and other such devices will use an application 251/254 for monitoring and control (i.e., smart phone 202—but not smart phone 203 because it belongs to the non-teleworking parent). The application 251/254 will be able to change parameters based on the user via the account of the person using it 251/254.

In the case of this household, each device may have to be registered individually as most devices are legacy. Registration may comprise a series of prompts where the user chooses the type, make, and model of a device. Depending on the make and model, subsequent prompts may follow asking for various other information (e.g., MAC address, IP Address, Serial number, administrative log in and password, etc.). In the next diagram, an example of a technologically modern household will illustrate an easier method of registration.

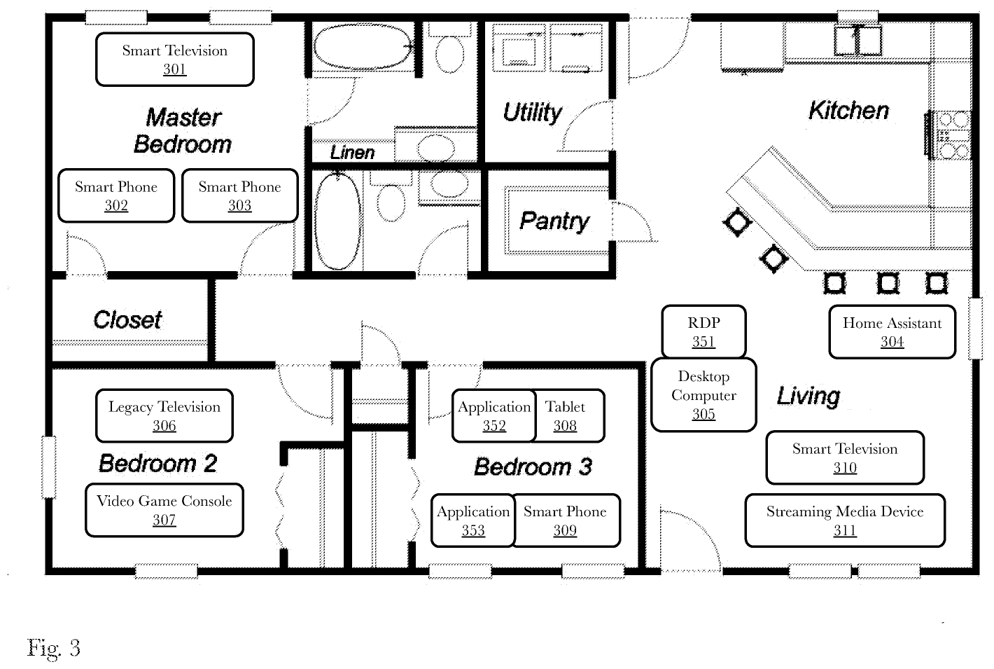

FIG. 3 is a diagram of an exemplary floor plan illustrating a second possible combination of household electronics 301-311 that are controlled and monitored by an attention management platform. This diagram also assumes a family of four with two children but with modern technology. One significant feature of this combination of household electronics is that it features a home assistant (GOOGLE HOME, AMAZON ALEXA, etc.). A home assistant 304 is typically already linked with the compatible devices in the house (301, 307, 310, 311 and this makes registration easier. This means that during the registration of devices in a user's profile, an API request may be made, or an application installed/run on the home assistant 304 in order to automatically detect some or all of the devices. Furthermore, an application designed to run on a third party home assistant 304 and one that would be communicatively coupled to a control server, would be able to request permissions to control the devices and act as a proxy for the control server.

Some routers also have management tools on their firmware which may be utilized for automatic registration of devices, or at least make it easy for users to gain access to all the networked devices information in a home. It is possible also to use network scanning tools, possibly built into the application 309/311 that can retrieve a mac addresses' OUI (Organizationally Unique Identifier) and in turn identify the type of device.

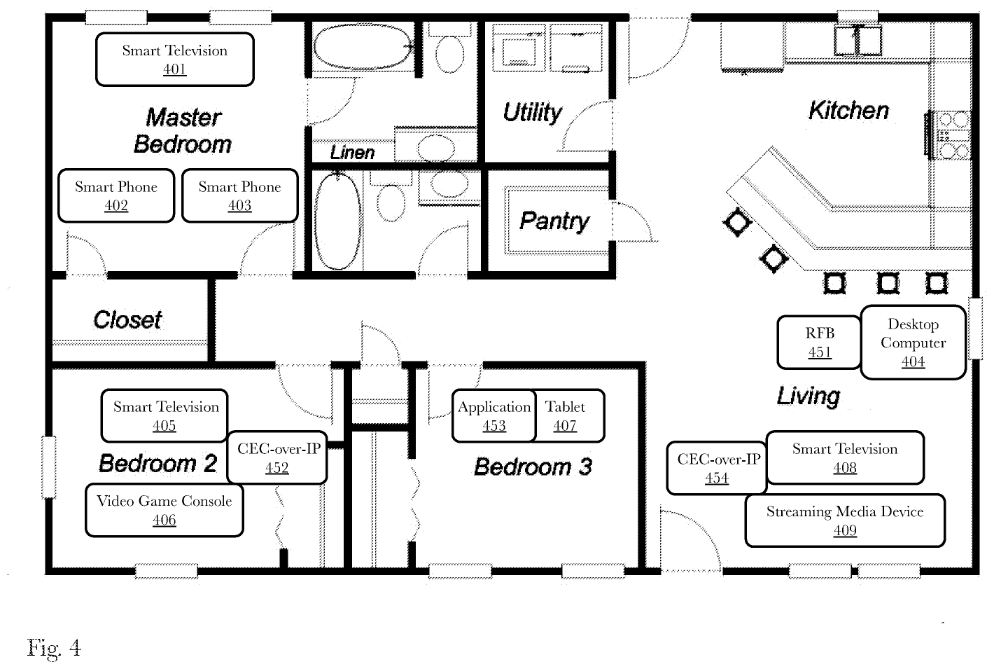

Speaking now of the legacy television 307, an external device may not be needed if the only media played on it is the video game system, because the video game system 308 may be monitored and controlled independent of the legacy television 307, (via CEC as one example). This exemplary household differs from the one in FIG. 2 because neither parent is bound by their employer to use an attention management platform, however, both children here are. It is likely that the parents and the schoolwork together to decide which devices to register. It may be that all devices all registered but only certain ones are active for each child's profile. For example, imagine that the parents install an application/service on the home assistant, the application/service being part of an attention management platform, and that now the linked devices 301, 307, 310, 311 are registered. The parents finish by registering the family desktop computer 305 (which may use an application with RDP 351 as one example), and the one child's tablet 308 and smart phone 309 by downloading again, an application/service 352/353 that is part of an attention management platform. It can be deduced that the smart television of the parents 301 is registered by the home assistant 304, but will not be controlled or monitored by the school as it will not be accessible or off-limits to the children. Further, it can be seen that one child may have only the video game console 307, desktop computer 305, smart television 310, and streaming media device 311 active for monitoring and control in his or her profile while the other child has all of the above with the exception of the video game console replaced by the tablet 308 and smart phone 309. The point of the examples contained in FIG. 2, FIG. 3, and FIG. 4 is to show that any combination of electronics may be monitored and controlled, and the decision of which devices is ultimately decided between the convening parties.

FIG. 4 is a diagram of an exemplary floor plan illustrating a third possible combination of household electronics that are controlled and monitored by an attention management platform. This diagram illustrates how a technologically modern home void of a home assistant may have its electronic devices 401-409 monitored and controlled via CEC-over-IP devices 452/454 along with applications/remote desktop 453/451.

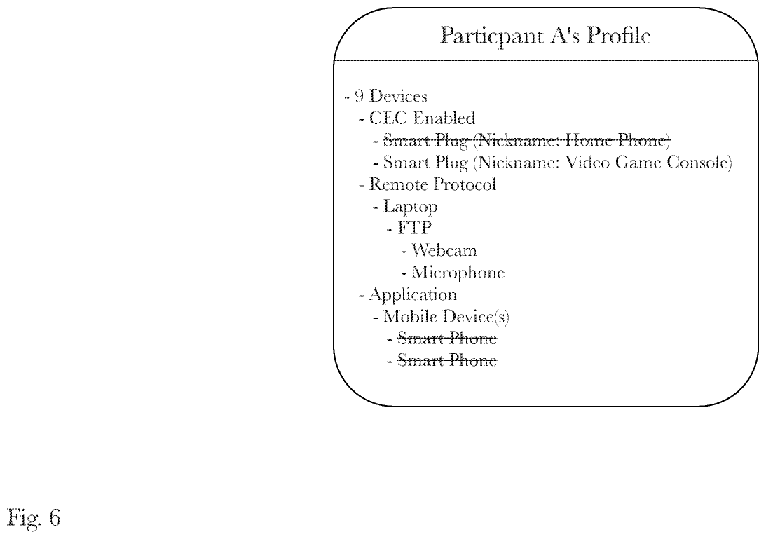

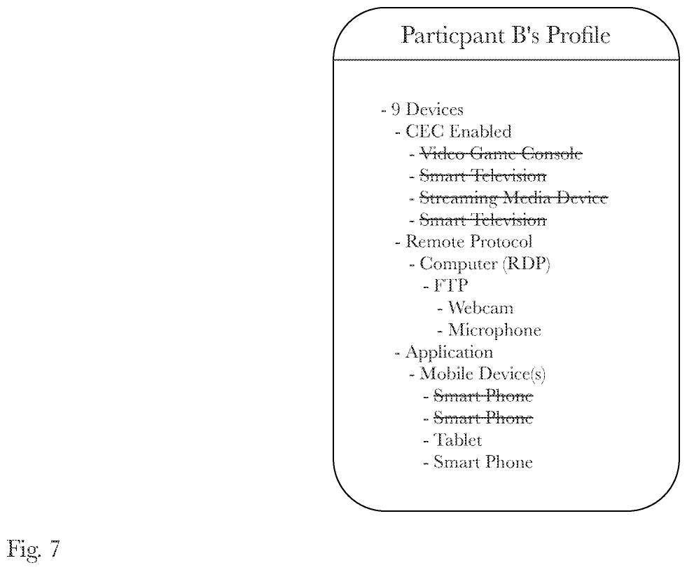

FIG. 6 and FIG. 7 are diagrams illustrating an exemplary user interface element that a participant of a teleconference/telemeeting may be presented with to register his or her devices by an attention management platform. As discussed above, there is a plurality of combinations of electronic devices that may be registered, and even further a plurality of registered devices that may or may not be active in each separate account of an individual in a household. In FIG. 6 and FIG. 7, it can be seen that both participant A and participant B have a plurality of devices registered but that some of the devices are not active for that participant's profile (represented as strikethrough text), meaning those devices are not monitored or controlled by a host. This UI element is what a user may see when registering devices, to be differentiated from the UI element presented to a host as in FIG. 5.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

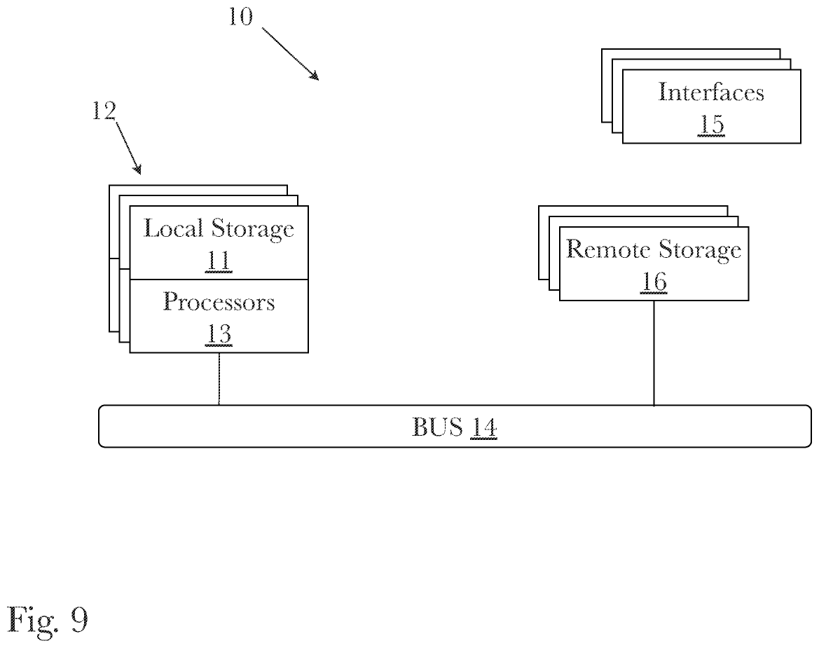

Referring now to FIG. 9, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some aspects, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 9 illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device aspects may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

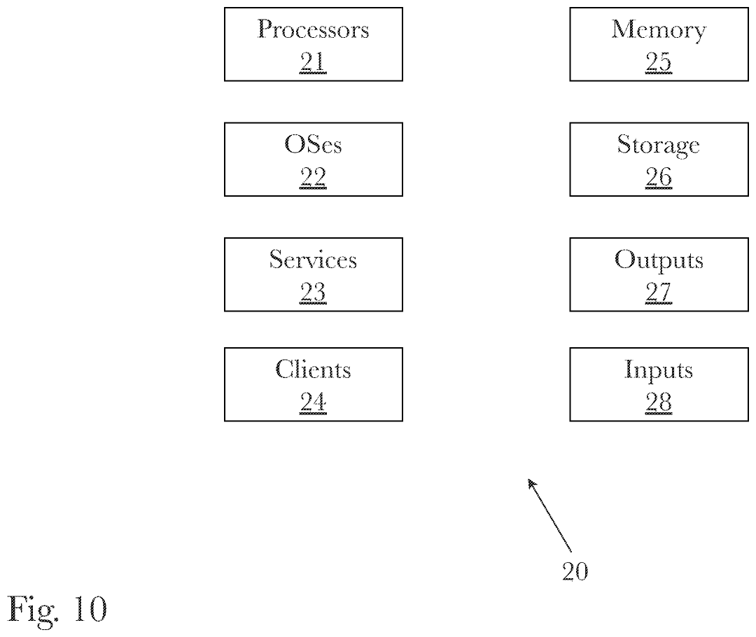

In some aspects, systems may be implemented on a standalone computing system. Referring now to FIG. 10, there is shown a block diagram depicting a typical exemplary architecture of one or more aspects or components thereof on a standalone computing system. Computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 9). Examples of storage devices 26 include flash memory, magnetic hard drive, CD-ROM, and/or the like.

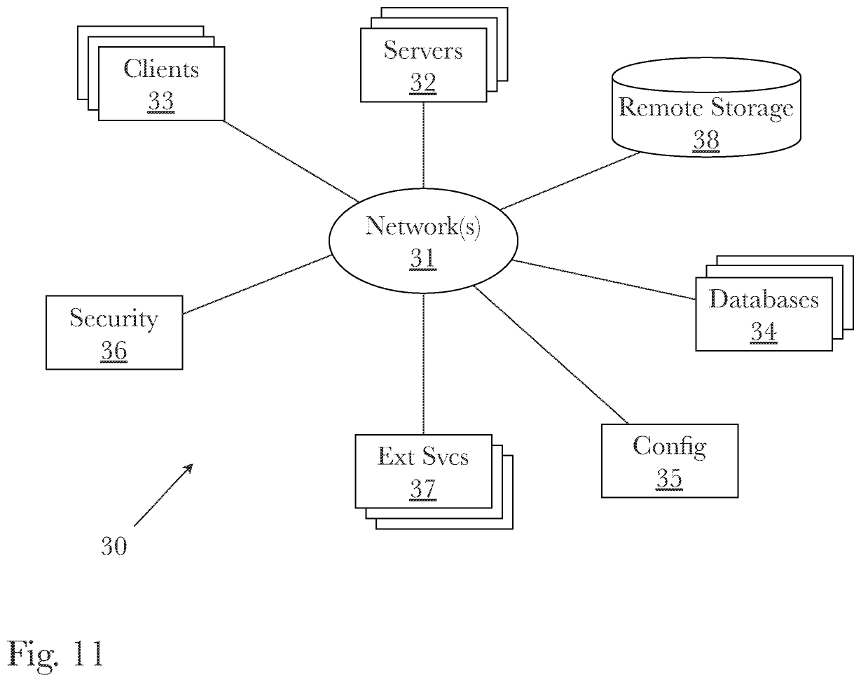

In some aspects, systems may be implemented on a distributed computing network, such as one having any number of clients and/or servers. Referring now to FIG. 11, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 10. In addition, any number of servers 32 may be provided for handling requests received from one or more clients 33. Clients 33 and servers 32 may communicate with one another via one or more electronic networks 31, which may be in various aspects any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises. In addition to local storage on servers 32, remote storage 38 may be accessible through the network(s) 31.

In some aspects, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and using a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with aspects without limitation, unless a specific security 36 or configuration system 35 or approach is specifically required by the description of any specific aspect.

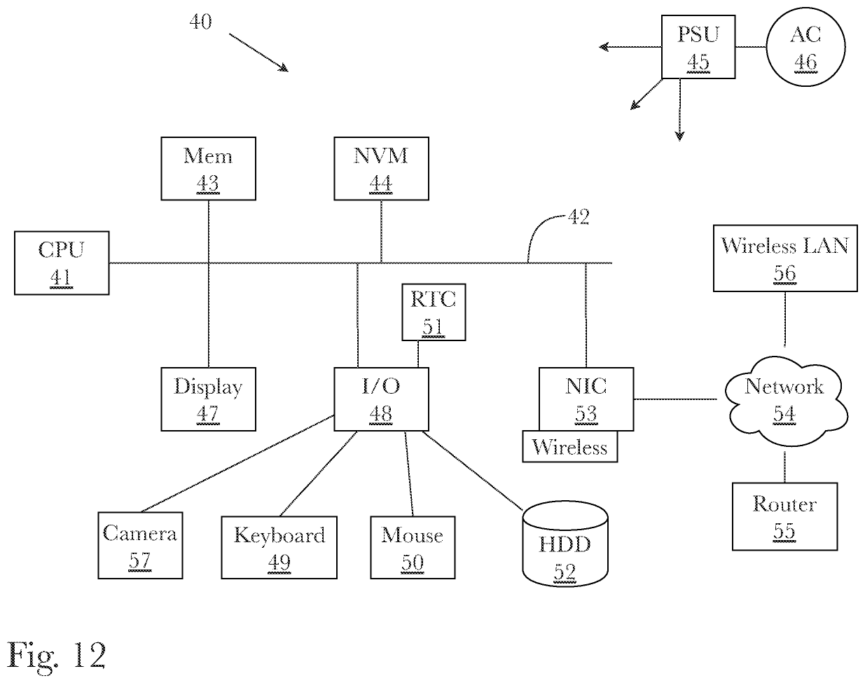

FIG. 12 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to peripherals such as a keyboard 49, pointing device 50, hard disk 52, real-time clock 51, a camera 57, and other peripheral devices. NIC 53 connects to network 54, which may be the Internet or a local network, which local network may or may not have connections to the Internet. The system may be connected to other computing devices through the network via a router 55, wireless local area network 56, or any other network connection. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various aspects, functionality for implementing systems or methods of various aspects may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various aspects described above. Accordingly, the present invention is defined by the claims and their equivalents.

What is claimed is:

1. A system for attention management, comprising:
an attention management platform comprising at least a plurality of programming instructions stored in a memory of, and operating on at least one processor of, a computing device, wherein the plurality of programming instructions, when operating on the at least one processor, causes the computing device to:
receive a new account profile, wherein the new account profile comprises a plurality of information about a participant;
receive one or more electronic device profiles associated with the new account profile, wherein each of the one or more electronic device profiles comprises information about one electronic device, and wherein the information about one electronic device comprises an address of the one electronic device used for communication and an active status relating to the ability to monitor and control said device;
initiate a teleconference between at least two participants, wherein at least one of the participants is a host;
retrieve the status of all the active electronic devices associated with all the participants, except the host, in the teleconference;
receive instruction from the host regarding which of the active electronic devices are authorized;
create an alert if an unauthorized electronic device is used;
receive an instruction from the host regarding the unauthorized electronic device; and
perform the instruction from the host regarding the unauthorized electronic device.

2. The system of claim 1, wherein an application available for participant electronic devices is communicatively coupled to the attention management platform.

3. The system of claim 2, wherein the application allows the host to remotely monitor and control the electronic device of which the application is installed.

4. The system of claim 1, wherein a third party software initiates the teleconference.

5. The system of claim 4, wherein an API is provided for the third party teleconference software to utilize the functions of the attention management platform.

6. The system of claim 1, wherein the instruction from the host is a command to turn the electronic device off or on.

7. The system of claim 1, wherein the instruction from the host is a command to send a notification to the participant to turn the electronic device off or on.

8. The system of claim 1, wherein the electronic devices' address used for communication comprises a physical CEC address and a logical CEC address.

9. The system of claim 1, wherein the electronic devices' address used for communication comprises an IP address.

10. The system of claim 1, wherein the electronic devices' address used for communication comprises a remote desktop protocol address.

11. A method for attention management, comprising the steps of:
receiving a new account profile, wherein the new account profile comprises a plurality of information about a participant;
receiving one or more electronic device profiles associated with the new account profile, wherein each of the one or more electronic device profiles comprises information about one electronic device, and wherein the information about one electronic device comprises an address of the one electronic device used for communication and an active status relating to the ability to monitor and control said device;
initiating a teleconference between at least two participants, wherein at least one of the participants is a host;
retrieving the status of all the active electronic devices associated with all the participants, except the host, in the teleconference;
receiving instruction from the host regarding which of the active electronic devices are authorized;
creating an alert if an unauthorized electronic device is used;
receiving an instruction from the host regarding the unauthorized electronic device; and
performing the instruction from the host regarding the unauthorized electronic device.

12. The method of claim 11, wherein an application available for participant electronic devices is communicatively coupled to the attention management platform.

13. The method of claim 12, wherein the application allows the host to remotely monitor and control the electronic device of which the application is installed.

14. The method of claim 11, wherein a third party software initiates the teleconference.

15. The method of claim 14, wherein an API is provided for the third party teleconference software to utilize the functions of the attention management platform.

16. The method of claim 11, wherein the instruction from the host is a command to turn the electronic device off or on.

17. The method of claim 11, wherein the instruction from the host is a command to send a notification to the participant to turn the electronic device off or on.

18. The method of claim 11, wherein the electronic devices' address used for communication comprises a physical CEC address and a logical CEC address.

19. The method of claim 11, wherein the electronic devices' address used for communication comprises an IP address.

20. The method of claim 11, wherein the electronic devices' address used for communication comprises a remote desktop protocol address.
